(19) United States
(12) Patent Application Publication
(10) Pub. No.: US 2011/0017330 A1
(43) Pub. Date: Jan. 27, 2011

(54) MAXIMUM PRESSURE HYDRAULIC VALVE

(76) Inventor: Vincenzo Di Leo, Milano (IT)

Correspondence Address: Steinfl & Bruno, 301 N Lake Ave Ste 810, Pasadena, CA, 91101, US

(21) Appl. No.: 12/866,030

(22) PCT Filed: Feb. 6, 2008
(86) PCT No.: PCT/IT08/00074

§ 371 Date: Oct. 15, 2010

(51) Int. Cl. F16K 15/14

(52) U.S. Cl. 137/844

(57) ABSTRACT

This hydraulic valve (1) comprises a valve body (2), an inlet mouth (3) of flow into the valve body (2), provided with a substantially non-deformable two-dimensional section, and a selective passage port (4) of flow in the valve body (2) having a linear section widenable under the flow pressure. The valve body (2) is formed with two sheets (21, 22) made of deformable material, adjacent to each other at the selective passage port (4), sealed together at their respective external edges (23, 24) extended from the inlet mouth (3) to the selective passage port (4) and sealed together around the inlet mouth (3). The structure with the two adjacent sheets (21, 22) guarantees an ideal closure of the selective passage port (4) when the delivery pressure is lower than a preset value, in that the selective passage port is formed with an intrinsically linear shape.

The present invention refers to a maximum pressure hydraulic valve, in particular for regulation of flow comprising solid or semi-solid material in a liquid component,

Maximum pressure hydraulic valve means a hydraulic valve which allows the passage of flow only if exceeding a preset delivery pressure.

Currently known are one-way hydraulic valves, also referred to as non-return valves, intended for various applications, which preferably allow flow towards a delivery direction while they prevent flow towards the opposite return direction. The typical technical characteristics required of a one-way hydraulic valve are evidently the capacity to effectively prevent the flow from flowing towards the return direction, even in the presence of relatively high counterpressures, and the capacity not to hinder the flow towards the delivery direction, even in the presence of a relatively low flow pressure.

Some use situations are particularly critical, such as in cases where the flow passing through the valve is not entirely liquid, but also contains some solid or semi-solid material. Such is the case of both civil and industrial waste water treatment plants.

In this context, semi-solid material means any material which—though not being solid—is not capable of flowing on its own, but which if mixed with liquid material can flow with it; for example, it is the case of doughy materials.

In this case, the valve must not be subject to easy clogging or blocking by the solid or semi-solid material contained in the flow.

Regarding this kind of applications, known are the so-called duckbill valves, which are provided with a deformable valve body between the circular inlet mouth and a linear outlet mouth, with two adjacent edges; under the flow pressure, the outlet mouth—usually closed—opens due to the deformation of the valve body, letting the flow pass towards the delivery direction. Instead, on the opposite direction, flow is not possible as any flow pressure on the outlet mouth does not trigger its opening, but rather tightens the closure.

Known valves of this type are made from a tubular body which is deformed permanently by means of transverse compressing on one side, thus creating the linear outlet mouth. These valves are appreciated for their simplicity, however they are not entirely adequate in terms of sealing against counterpressures, even at low amounts.

As a matter of fact, it is possible that the deformation of the tubular body leaves small end areas not perfectly adjacent between two inlet mouth edges, due to the imperfect deformability of the material of the tubular body.

Other known valves of this type are made directly according to the desired shape, for example through injection moulding of a suitable elastomeric material. These valves are appreciated for their efficient operation, but they imply rather high production costs.

Actually, the abovementioned one-way duckbill valves are often employed for waste water even in cases where allowing flow towards one direction and preventing it towards the opposite direction is not strictly necessary, instead allowing flow only above a preset delivery pressure is necessary. As a matter of fact, on one hand, the shape of these valves is particularly suitable for flows also containing solid or semi-solid material, without the risk of clogging, while on the other hand, these valves actually serve as maximum pressure valves, in that they open only upon reaching a preset delivery pressure.

The technical problem on which the present invention is based is that of manufacturing a maximum pressure hydraulic valve capable of guaranteeing safe operation even when employed for waste waters, and which is easy to manufacture at low production costs.

Consequently, the present invention regards a valve according to claim 1. Preferred characteristics are outlined in the dependent claims.

More in particular, the invention regards a maximum pressure hydraulic valve, comprising a valve body, an inlet mouth for flow into the valve body, having a substantially non-deformable two-dimensional section, and a selective passage port of the flow in the body valve provided with a linear sections widenable under the flow pressure, characterised in that the valve body is formed with two sheets made of deformable material, arranged adjacent to each other at the selective passage port, sealed together at their respective external edges extended from the inlet mouth to the selective passage port and sealed together around the inlet mouth.

The structure with the two adjacent sheets guarantees an ideal closure of the selective passage port when the delivery pressure is lower than a preset value, in that the selective passage port is formed with an intrinsically linear shape. Furthermore, manufacturing such kind of a valve is extremely easy, in that it does not require use of expensive moulds for injection or moulding operations.

The inlet mouth can be cylindrical or frusto-conical shaped, with a section that narrows towards the selective passage port. The second solution determines a greater rigidity of the valve, and thus a higher opening pressure, under equivalent conditions. More precisely, it was observed that the abovementioned frusto-conical shape of the inlet mouth applies on the adjacent sheets forming the valve body a deformation such that the valve tends to spontaneously maintain the closure position; hence, the valve also guarantees an ideal closure under static conditions, that is substantially still flow condition, or substantial absence of pressure difference condition between upstream and downstream the valve.

Preferably, the two sheets are sealed together at their respective external edges by means of gluing and/or welding and/or seaming. The choice of one these fixing methods shall be made depending on the characteristics of the material of the sheets themselves and the pressure resistance requirements of the valve.

In case of particularly high operating pressures, the valve preferably comprises, along the external sealed edges, two pairs of reinforcement bars, interlocked to each other with the interposition of the sheets; these bars ensure in a mechanical manner resistance of the sealing along the external edges, even under extremely high operating pressures.

Preferably, the valve comprises a rigid tubular insert at the inlet mouth. This facilitates mounting the valve, in that the tubular insert can be coupled with any hydraulic system just like a simple pipe.

According to a preferred embodiment, the valve comprises a rigid tubular insert of an approximately frusto-conical shape flattened at the inlet mouth, said insert being provided with a perimeter flange. An insert thus made allows both manufacturing a valve capable of operating even under extremely high pressure conditions, and connecting the valve to a hydraulic circuit in a particularly easy manner.

Preferably, the two sheets are sealed together around the rigid tubular insert at the inlet mouth by force fitting onto the insert and/or gluing and/or welding. The choice of one of the these fixing methods shall be performed depending on the characteristics of the material of the sheets themselves and the pressure resistance requirements of the valve.

In case of particularly high operating pressures, the valve preferably comprises, around the two sheets at the inlet mouth, two interlocked reinforcement brackets; these brackets ensure in a mechanical manner the resistance of the sealing at the inlet mouth, even under extremely high operating pressures.

The inlet mouth may be formed with different shapes. According to an embodiment, preferred for its simplicity, the inlet mouth has a circular section.

The selective passage port can have a rectilinear or curvilinear section. A curvilinear section is preferred in case of extremely high operating pressure, as its confers more rigidity to the outlet mouth itself; such shape also ensures a higher closure capacity as soon as the delivery pressure flow drops below the minimum level.

Preferably, the valve body has a curved profile, in proximity to the selective passage port, in a longitudinal direction or transverse direction with respect to the flow. A curved profile in proximity to the selective passage port is preferred in the presence of extremely high operating pressure, as it confers more rigidity to the selective passage port.

According to a preferred embodiment, the valve comprises an outlet mouth for the flow from the valve body, coinciding with the selective passage port. In this manner, the valve appears shaped like a duckbill valve and serves as a one-way valve; as a matter of fact, the flow from the outlet mouth towards the inlet mouth is hindered.

According to a different preferred embodiment, the valve comprises an outlet mouth of flow from the valve body, spaced from the selective passage port and provided with a substantially non-deformable two-dimensional section, the two sheets being sealed together also around the outlet mouth. In this manner, the valve has a—so to say—double duckbill shape, and serves as a two-directional valve, interrupting and allowing the flow depending on the delivery pressure in either direction.

Preferably, the outlet mouth is frusto-conical shaped, with a section narrowing towards the selective passage port of the valve body, when more rigidity is required.

Analogously to the previous description of the inlet mouth, the valve may comprise a rigid tubular insert at the outlet mouth, to facilitate mounting the valve. Analogously, the two sheets can be sealed together around the rigid tubular insert at the outlet mouth by force fitting onto the insert and/or gluing and/or welding, and around the two sheets at the outlet mouth two interlocked reinforcement brackets can be provided.

According to a preferred embodiment, the outlet mouth and the inlet mouth are frusto-conical shaped, with sections narrowing towards the selective passage port of the valve body, the conicity of the outlet mouth differing from the conicity of the inlet mouth. This shape allows to have different intervention pressures (that is opening of the valve) towards the two flow directions.

Further characteristics and advantages of the present invention shall be clearer from the following detailed description of some of its preferred embodiments, provided with reference to the attached drawings. In such drawings,

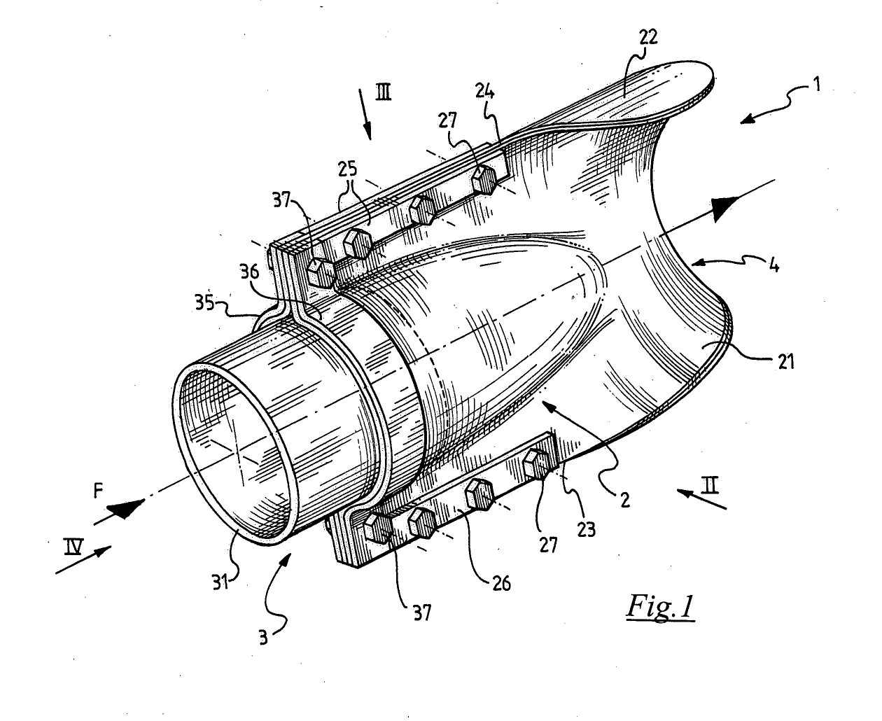

FIG. 1 is a perspective view of the valve according to the invention;

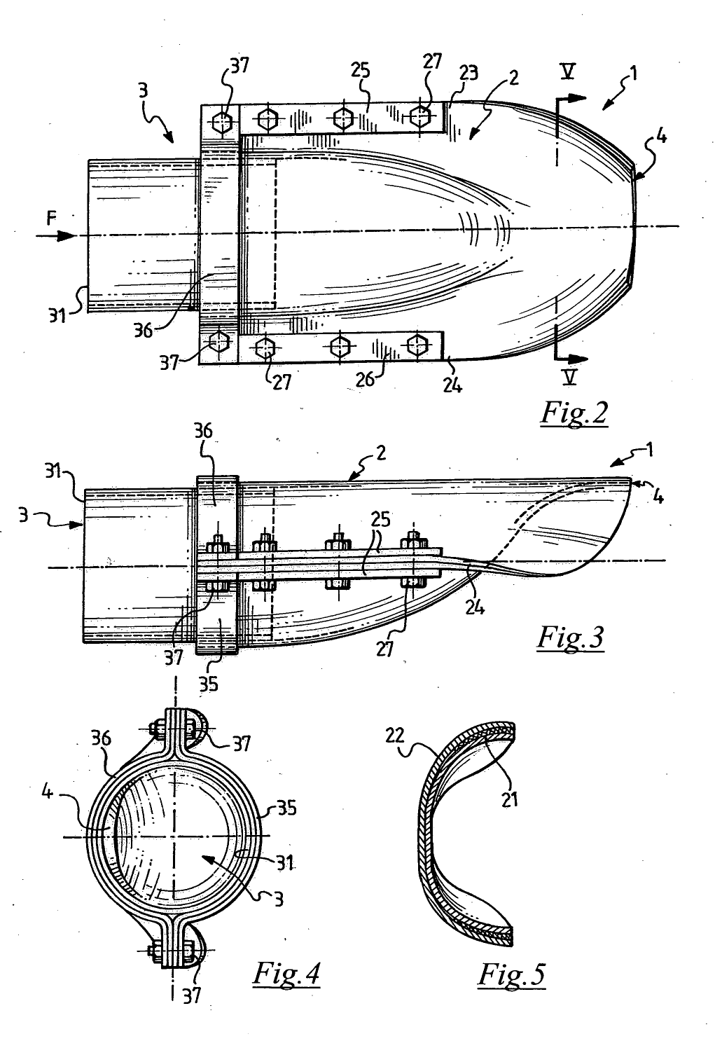

FIGS. 2, 3 and 4 are views of the valve of FIG. 1, taken along directions II, III and IV;

FIG. 5 is a section view of the valve of FIG. 1, taken along line V-V;

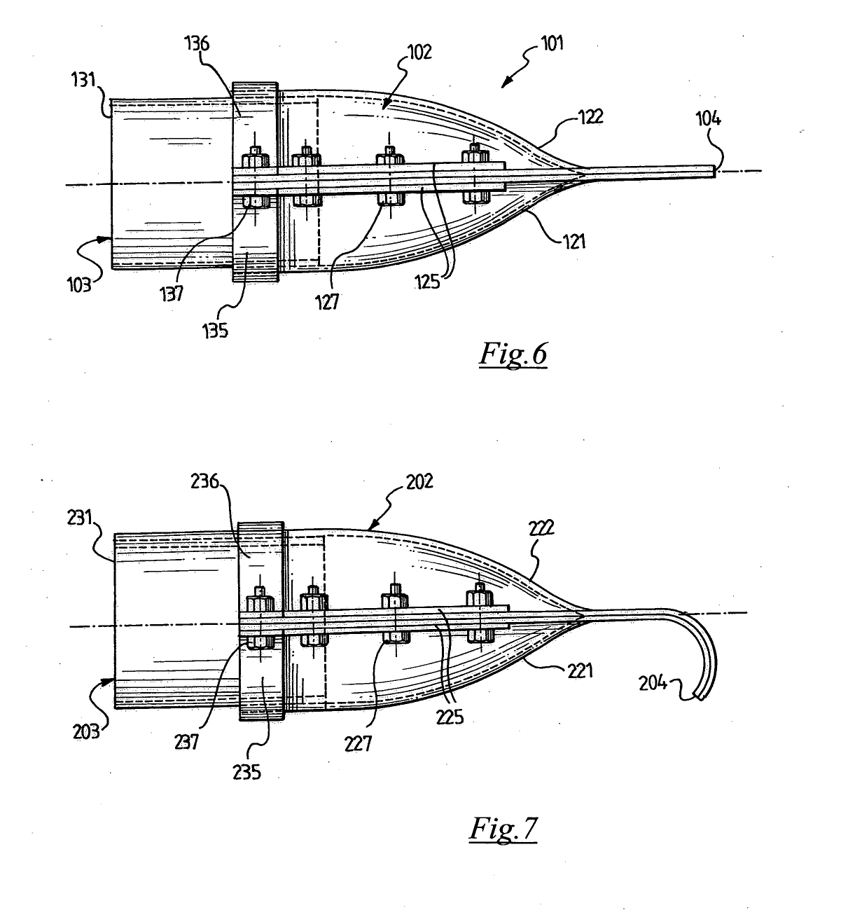

FIGS. 6 and 7 are views analogous to FIG. 3 of valves according to alternative embodiments of the invention;

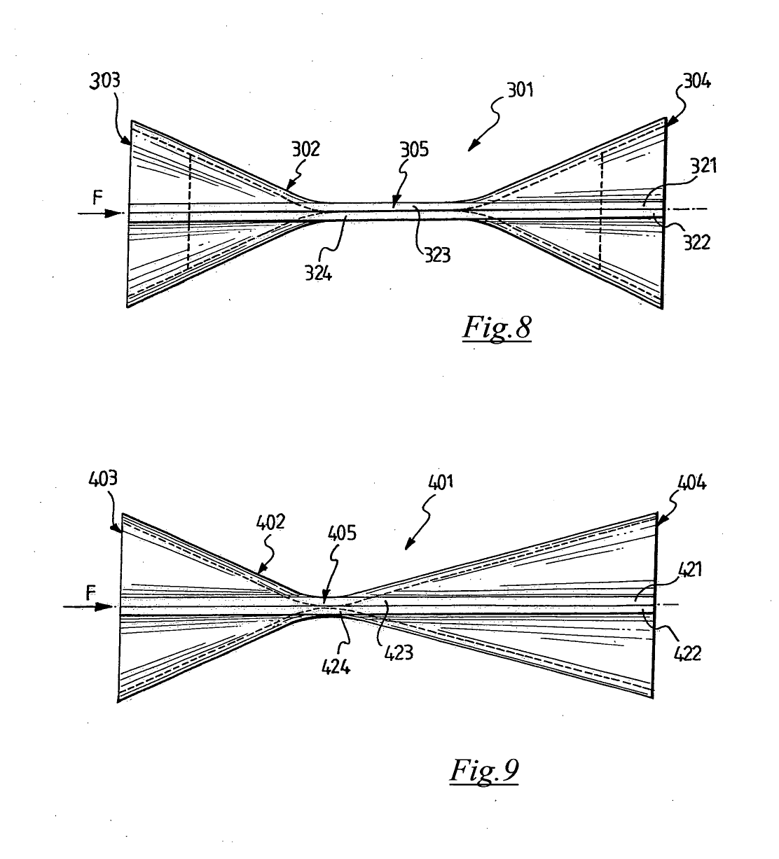

FIGS. 8 and 9 schematically show two-directional valves, according to different embodiments of the invention;

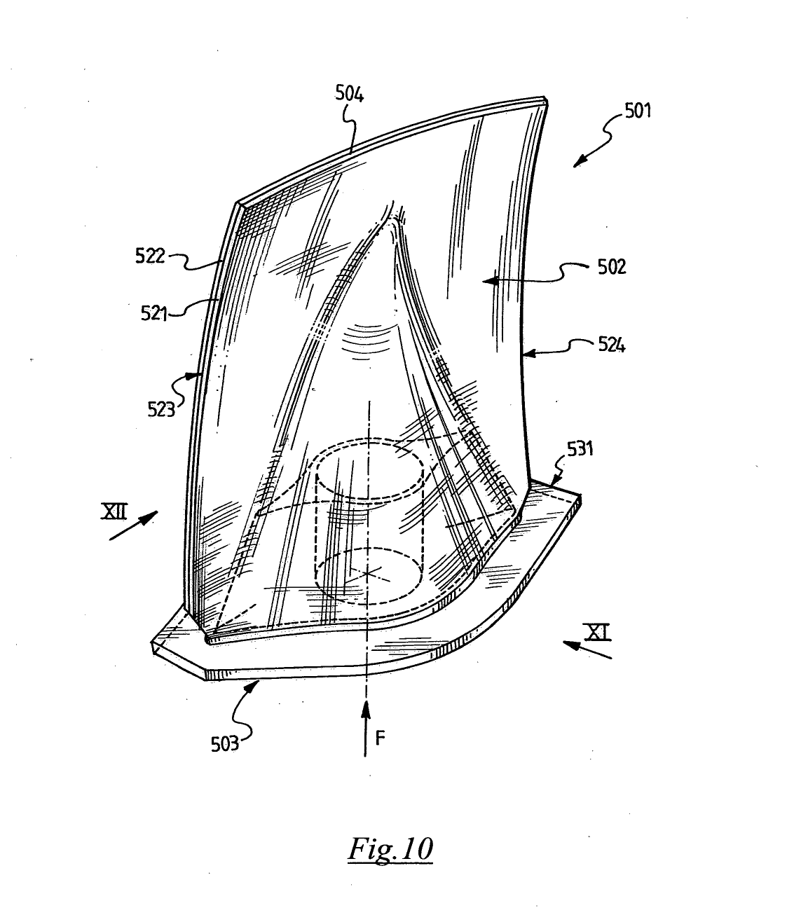

FIG. 10 is a perspective view of a valve according to a further embodiment of the invention;

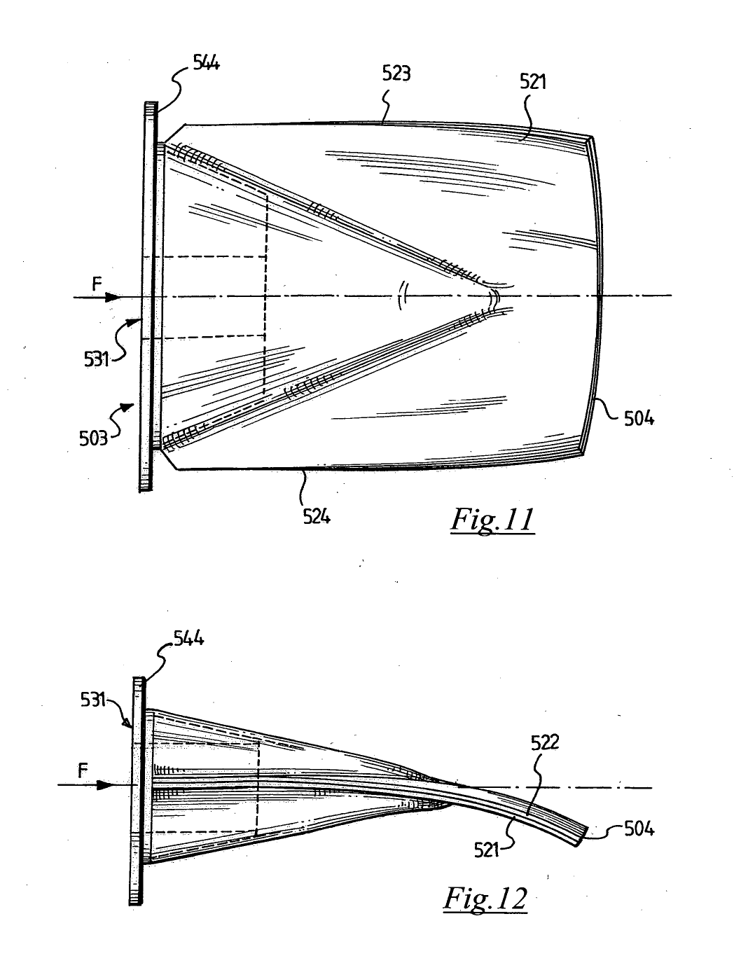

FIGS. 11 and 12 are views of the valve of FIG. 10, taken along direction XI and XII;

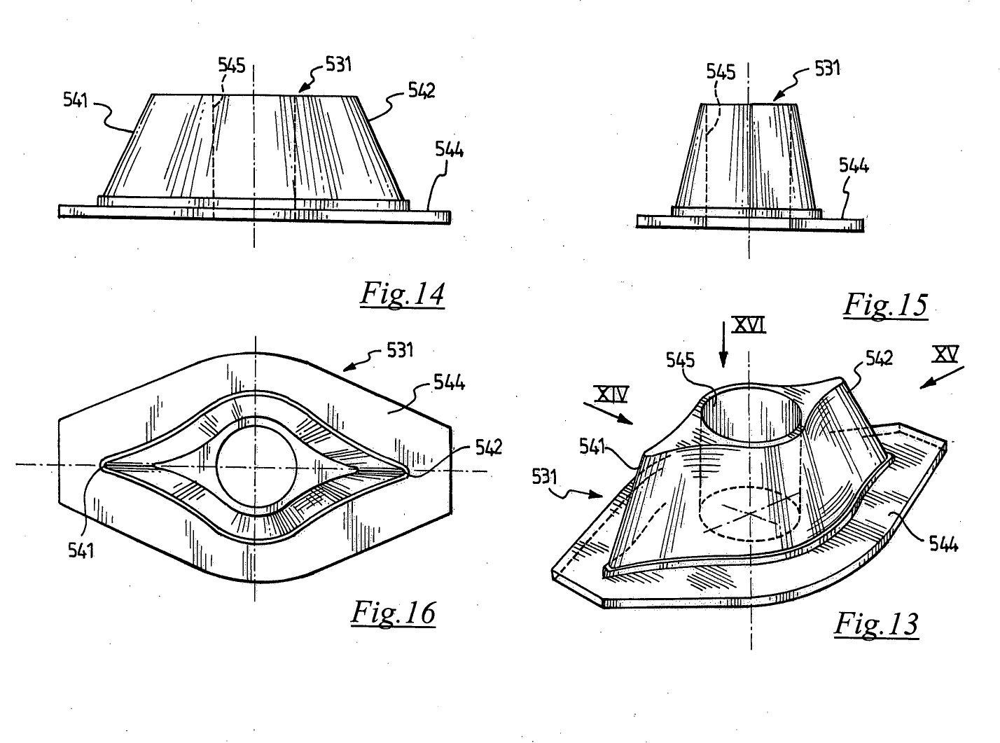

FIG. 13 is a perspective view of an insert of the valve of FIG. 10;

FIGS. 14, 15, 16 are views of the insert of FIG. 13, taken along directions XIV, XV and XVI.

In FIGS. 1 to 5, 1 indicates a one-way hydraulic valve according to the invention, which allows flow towards direction F and prevents flow towards the opposite direction.

The valve 1 comprises a valve body 2, extended between an inlet mouth 3 and an outlet mouth 4 of flow towards direction F. The valve body 2 comprises two sheets 21 and 22 made of deformable material, which are adjacent to each other at the outlet mouth 4, which thus appears linear, that is one-dimensional; furthermore, the two sheets 21 and 22 are sealed together at the external edges 23 and 24 of the valve body, extended between the inlet mouth 3 and the outlet mouth 4; lastly, the two sheets 21 and 22 are sealed together around a rigid tubular insert 31, at the inlet mouth 3. The tubular insert 31 is cylindrical, that is with a circular section constant along its entire length; alternatively, such insert could be frusto-conical shaped, with the conicity directed in such a manner that the circular section narrows towards the centre of the valve body 2.

The two sheets 21 and 22 are made of particularly resistant, though deformable, elastomeric material. The choice of the type and thickness of the material shall be performed depending on the required rigidity of the valve, in turn determined by the operating pressure.

The inlet mouth 3 is thus substantially non-deformable and permanently open, with a substantially circular section, while the outlet mouth 4 is deformable, usually closed but can be opened under flow pressure towards direction F exceeding a preset value, sufficient to widen the two sheets 21 and 22; any counterpressures towards the direction opposite to F cannot widen the sheets 22 and 23 at the outlet mouth 4 and thus cannot trigger the opening of the outlet mouth 4 itself. Thus, a one-way operation of the valve 1 is obtained, in which the outlet mouth 4 provides a selective passage port for the flow.

The sealing of the two sheets 21 and 22 along the edges 23 and 24 is obtained by means of gluing and/or welding and/or seaming, depending on the material the sheets are made of, in such a manner to guarantee both the mechanical resistance of the valve body 2 and the resistance of the sealing: under the maximum pressure conditions provided for the flow, neither should the two sheets separate nor should flow leakages towards the external occur. In order to guarantee maximum mechanical resistance and the sealing in applications with extremely high flow pressures, there are provided two pairs of bars 25 and 26 interlocked and fastened to each other by means of bolts 27 (or other analogous means) in such a manner to wrap and tighten the two sheets 21 and 22 against each other.

Also the sealing of the two sheets 21 and 22 therebetween and to the tubular insert 31 at the entrance mouth 3 is obtained by means of gluing and/or welding and/or seaming, depending on the material the sheets and the tubular insert are made of, in such a manner to guarantee both the mechanical resistance of the valve body 2, and the resistance of the sealing: under the maximum pressure conditions provided for the flow, neither should the two sheets separate from each other or from the tubular insert 31, nor should flow leakages towards the external occur. In order to guarantee maximum mechanical resistance and of the sealing in applications with extremely high flow pressures, there are provided two brackets 35 and 36 interlocked and fastened to each other around the sheets 21 and 22 and the insert 31 by means of bolts 37 (or other analogous means).

The inlet mouth 3 has a rounded two-dimensional section, more precisely circular; the outlet mouth 4 has a curvilinear linear section, substantially curved in a transverse direction with respect to flow direction F, in that the portion of the valve body 2 is curved in a transverse direction in proximity to the outlet mouth 4. This curving confers special rigidity to the outlet mouth 4, ensuring the closure of the mouth 4 as soon as the flow pressure towards direction F drops below the preset level.

FIG. 6 shows a valve 101 according to a different embodiment of the invention. The valve 101 is analogous to valve 1 and similarly to the latter it is a one-way valve; its parts corresponding to the parts of valve 1 are referred to by the same reference numbers, increased by 100. Thus the valve 101 comprises a valve body 102, an inlet mouth 103 and an outlet mouth 104, coinciding with a selective passage port; the valve body 102 comprises two sheets 121 and 122 coupled along the edges 123 and 124, with the aid of reinforcement bars 125 and 126 and bolts 127; at the inlet mouth 103, two brackets 135 and 136 with bolts 137 sealingly fasten the sheets 121 and 122 around a tubular insert 131.

Differently with respect to valve 1, the outlet mouth 104 of the valve 101 is rectilinear without any transverse curving. This leads to an outlet mouth 104 more deformable with respect to the mouth 4 of valve 1, and thus a valve 101 more suitable for relatively lower operating pressures and for flows of solid components of relatively higher dimensions.

FIG. 7 shows a valve 201 according to a different embodiment of the invention. Valve 201 is also analogous to valve 1 and similar to the latter it is a one-way valve; its parts corresponding to the parts of valve 1 are referred to by the same reference numbers, increased by 200. Thus the valve 201 comprises a valve body 202, an inlet mouth 203 and an outlet mouth 204, coinciding with a selective passage port; the valve body 202 comprises two sheets 221 and 222 coupled along the edges 223 and 224, with the aid of reinforcement bars 225 and 226 and bolts 227; at the inlet mouth 203, two brackets 235 and 236 with bolts 237 sealingly fasten the sheets 221 and 222 around a tubular insert 231.

Differently with respect to valve 1, and analogously to valve 101, the outlet mouth 204 of the valve 201 is rectilinear, without any transverse curving; however, differently with respect to valve 101, the valve body 202 is curved longitudinally in proximity to the outlet mouth 204. This leads to an outlet mouth 204 more deformable with respect to the mouth 4 of valve 1, but less than mouth 104 of valve 101, and thus a valve 201 more suitable for intermediate operating pressures.

FIG. 8 shows a valve 301 according to a different embodiment of the invention. Contrary to valves 1, 101 and 201, valve 301 is two-directional.

Thus the valve 301 comprises a valve body 302, an inlet mouth 303, an outlet mouth 304 and selective passage port 305; the valve body 302 comprises two sheets 321 and 322 coupled along the edges 323 and 324. Both the inlet mouth 303 and the outlet mouth are frusto-conical shaped.

The valve 301, as mentioned, is two-directional, that is the selective passage port 305 is capable of opening when the delivery pressure (towards direction F or the opposite direction) reaches the preset intervention pressure.

FIG. 9 shows a two-directional valve 401 analogous to valve 301, provided with a valve body 402, an inlet mouth 403, an outlet mouth 404 and a selective passage port 405; the valve body 402 comprises two sheets 421 and 422 coupled along the edges 423 and 424. Both the inlet mouth 403 and the outlet mouth are frusto-conical shaped; the outlet mouth 404 has a smaller conicity (that is with walls inclined at a smaller angle with respect to direction F) than the inlet mouth 403.

The valve 401, similar to valve 301, is two-directional, that is the selective passage port 405 is capable of opening when the delivery pressure reaches the preset intervention pressure. Due to the different conicity, the intervention pressure towards direction F can be different with respect to the intervention pressure towards the opposite direction.

Other variants could be made to the valve according to the invention; for example, preformed sheets could be used to make a valve with a double curving in proximity to the outlet mouth, both in transverse and longitudinal directions. A valve thus made would be provided with an extremely rigid outlet mouth, adapted for application under extremely high pressures. Furthermore, also the valves provided with a curving could have a frusto-conical shaped cylindrical insert for the inlet mouth.

FIGS. 8-14 refer to another embodiment of the invention and show a valve 501 according to a different embodiment of the invention. The valve 501 is analogous to valve 1 and just like the latter it is a one-way valve; its parts corresponding to the parts of valve 1 are referred to by the same reference numbers, increased by 500. The valve 501 thus comprises a valve body 502, an inlet mouth 503 and an outlet mouth 504, coinciding with a selective passage port. The valve body 502 comprises two sheets 521 and 522 coupled along the edges 523 and 524, sealed together around a rigid tubular insert 531, at the inlet mouth 503.

Analogously to valve 201, the outlet mouth 504 of the valve 501 is rectilinear, without any transverse curving; however, the valve body 502 is curved longitudinally in proximity to the outlet mouth 504.

Differently from valve 1, the tubular insert 531 has an approximately frusto-conical shape flattened in a transverse direction, orthogonal with respect to direction F, between the two sheets 521 and 522. The insert 531 is thus provided with two side edges 541 and 542 made thin, which engage between the two sheets 521 and 522. Furthermore, the insert 531 is provided with a perimeter flange 544, on which the two sheets 521 and 522 abut. The flange 544 can be easily shaped as desired, depending on the intended use of the valve 501, in such a manner to facilitate the hydraulic connections of the valve 501.

It should be observed that the tubular insert 531 has an internal circular cylindrical passage 545, though different shapes can be easily provided.

In all the previously indicated embodiments wherein an inlet mouth (or also an outlet mouth, in case of a two-directional valve) is frusto-conical shaped, the rigidity of the valve and thus its capacity to bear high operating pressures increases proportionally to the increase of the conicity angle, meaning in this case the angle formed by a conical surface generatrix and the flow direction F. It was observed that under low operating pressures a conicity of few degrees is more than enough to provide the valve with the required rigidity; in addition, 20-40° conicities provide the valve with a rigidity suitable even under very high pressures; higher conicities can be provided in case of extremely high operating pressures.

In particular, it has been observed that the frusto-conical shape (circular like in valves 301 and 401 or better flattened like in valve 501) provides the adjacent sheets forming the valve body with a deformation such that the valve spontaneously tends to maintain a closed condition. The greater the conicity, the greater the tendency to maintain a closed condition, countering even relatively high pressures upstream. This characteristic is particularly important for example when the operation of the plant on which the valve is applied provides static conditions, in which the flow is substantially still; in this case, the valve guarantees resistance in closure. Analogously and even in a more significant manner, this characteristic is important when the closure must be maintained even under substantial pressure upstream; while the known duckbill valves are usually inadequate under this condition as they tend to open easily, a valve according to the invention provided with a conical-shaped inlet mouth is perfectly suitable; in this case the conicity selected shall be greater in proportion to the pressure under which the valve shall resist before opening.

1. A maximum pressure hydraulic valve, comprising
a valve body,
an inlet mouth of a flow into the valve body, the inlet mouth being provided with a substantially non-deformable two-dimensional section, and
a selective passage port of the flow into the valve body provided with a linear section widenable under flow pressure,
wherein
the valve body is formed with two sheets made of deformable material, adjacent to each other at the selective passage port sealed together at respective external edges extended from the inlet mouth to the selective passage port and sealed together around the inlet mouth.

2. The valve according to claim 1, wherein the inlet mouth is cylindrically shaped.

3. The valve according to claim 1, wherein the inlet mouth is frusto-conically shaped, with the section narrowing towards the selective passage port.

4. The valve according to claim 1, wherein the two sheets are sealed together at their respective external edges by means of gluing and/or welding and/or seaming.

5. The valve according to claim 4, comprising, along the sealed external edges, two pairs of interlocked reinforcement bars, with the interposition of the two sheets being interposed between said two pairs.

6. The valve according to claim 1, comprising a rigid tubular insert at the inlet mouth.

7. The valve according to claim 3, comprising a rigid tubular insert approximately frusto-conically flattened shaped at the inlet mouth, said insert being provided with a perimeter flange.

8. The valve according to claim 6, wherein the two sheets are sealed together around a rigid tubular insert at the inlet mouth by force fitting onto the insert and/or gluing and/or welding.

9. The valve according to claim 8, comprising, around the two sheets at the inlet mouth, two interlocked reinforcement brackets.

10. The valve according to claim 1, wherein the selective passage port has a rectilinear section.

11. The valve according to claim 1, wherein the selective passage port has a curvilinear section.

12. The valve according to claim 1, wherein the valve body has a curved profile, in proximity of the selective passage port.

13. The valve according to claim 1, wherein the valve body has a curved profile in a longitudinal direction with respect to the flow, in proximity to the selective passage port.

14. The valve according to claim 1, wherein the valve body has a curved profile in a transverse direction with respect to the flow, in proximity to the selective passage port.

15. The valve according to claim 1, comprising an outlet mouth of flow from the valve body, coinciding with the selective passage port.

16. The valve according to claim 1, comprising an outlet mouth of flow from the valve body, spaced from the selective passage port and provided with a substantially non-deformable two-dimensional section, the two sheets being sealed together also around the outlet mouth.

17. The valve according to claim 16, wherein the outlet mouth is frusto-conically shaped, with a section narrowing towards the selective passage port of the valve body.

18. The valve according to claim 16, wherein the outlet mouth and the inlet mouth are frusto-conically shaped, with sections narrowing towards the selective passage port of the valve body, wherein conicity of the outlet mouth is different from conicity of the inlet mouth.
